(19) United States
(12) Patent Application Publication
(10) Pub. No.: US 2012/0197859 A1
(43) Pub. Date: Aug. 2, 2012

(54) Apparatus and Method for Analyzing and Modifying Content

(75) Inventor: Andrew Simon Willis, Redditch (GB)

(73) Assignee: ClickScene Limited

(21) Appl. No.: 13/358,976

(22) Filed: Jan. 26, 2012

(30) Foreign Application Priority Data
Jan. 28, 2011 (GB) 1101474.23

(51) Int. Cl. G06F 17/30

(52) U.S. Cl. 707/706; 707/E17.108

(57) ABSTRACT

An apparatus and associated method, the apparatus including means for obtaining data relating to a website; means for determining a value of the data; and means for retrieving a stored recommendation corresponding to the determined value.

### FIELD OF THE INVENTION

Embodiments of the present invention relate to an apparatus and method for analyzing and modifying content. In particular, they relate to an apparatus and method for analyzing and modifying content to enable a search rating of a website to be improved.

### BACKGROUND TO THE INVENTION

Search engines which enable users to enter a search term to find associated websites are well known. The results of a search may be listed in accordance with the search rating of the website. Websites with a higher search rating may be listed above the websites with a lower search rating.

There are a number of factors which may affect the search rating of a website. For example, these may include, but are not limited to, the relevance of the search term to the content of the website, the number of other websites which link to the particular website, the format and relevance of links which link to the particular website, properties of the server hosting the website such as the physical location, the location of the user making the search, properties or other attributes of the website such as the speed in which content on the website can be downloaded or whether the website contains any malicious code etc.

It may be useful for owners of websites to control the content of the website or content associated with the website to improve the search rating of their website to increase the number of users of their website.

### BRIEF DESCRIPTION OF VARIOUS EMBODIMENTS OF THE INVENTION

According to various, but not necessarily all, embodiments of the invention there is provided an apparatus comprising: means for obtaining data relating to a website; means for determining a value of the data; and means for retrieving a stored recommendation corresponding to the determined value.

In some embodiments of the invention the apparatus may further comprise means for analysing the website to obtain data from the website. In some embodiments of the invention the apparatus may further comprise means for analysing data associated with a website where the data may be stored remotely from the website.

In some embodiments of the invention the data obtained may relate to the search engine rating of the website.

In some embodiments of the invention the apparatus may further comprise means for enabling a user to modify the stored recommendations. Modifying the stored recommendations may comprise the addition, deletion or editing of a stored recommendation.

In some embodiments of the invention the apparatus may comprise means for providing a notification to a user where the user provides an indication of the stored recommendation.

In some embodiments of the invention the apparatus may be configured to automatically obtain the data, determine the data value and retrieve a stored recommendation.

In some embodiments of the invention the apparatus may comprise means for implementing the retrieved recommendation.

According to various, but not necessarily all, embodiments of the invention there is provided a method comprising: obtaining data relating to a website; determining a value of the data; and retrieving a stored recommendation corresponding to the determined value.

According to various, but not necessarily all, embodiments of the invention there is provided a computer program which, when loaded into a processor, provides means for obtaining data relating to a website; means for determining a value of the data; and means for retrieving a stored recommendation corresponding to the determined value.

The apparatus may be for analyzing websites and modifying content associated with the websites.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus according to embodiments of the invention;

FIG. 2 illustrates a method according to embodiments of the invention; and

FIG. 3 illustrates a further method according to embodiments of the invention.

### DETAILED DESCRIPTION OF VARIOUS EMBODIMENTS OF THE INVENTION

The Figures illustrate an apparatus 1 comprising: means for obtaining data relating to a website; means for determining a value of the data; and means for retrieving a stored recommendation 15 corresponding to the determined value.

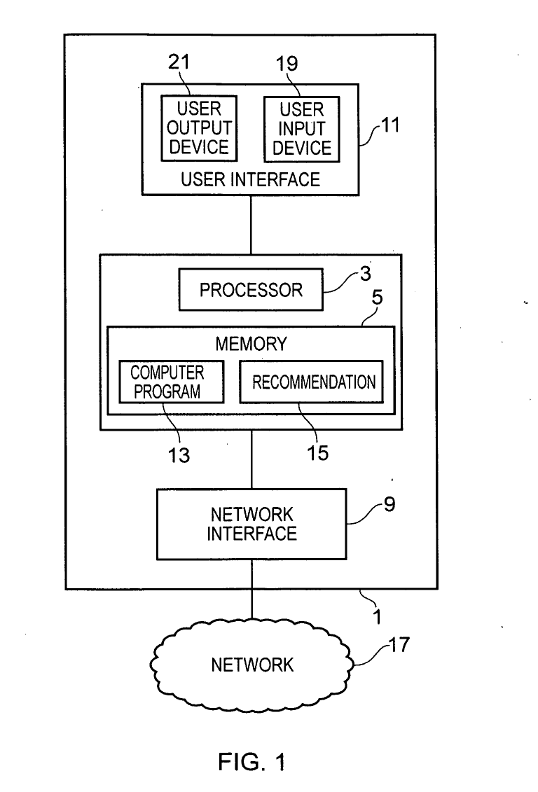

FIG. 1 schematically illustrates an apparatus 1 according to embodiments of the invention. FIG. 1 may be any apparatus 1 which is configured to enable a user to analyze content. The apparatus may also be configured to enable the content to be modified in response to the analysis. For example, the apparatus may be a computer or a network of computers or a server.

In some embodiments of the invention the content which is analyzed may comprise or be associated with a website. For example, the content may comprise text and/or images which are presented to a user when they access a website. The content may also comprise items which are not visible to the user, for example, it may comprise items which enable information to be passed between a browser and a server. In some embodiments of the invention content may also comprise data associated with the website such as the number of times the website has been accessed within a given time period or the number of times the website is linked by other websites. The content may be stored in a different location to the content which makes up the website itself. In such embodiments of the invention the content may be analyzed in order to improve the search rating of the website.

The apparatus illustrated in FIG. 1 comprises a controller 7 a network interface 9 and a user interface 11. It is to be appreciated that only components essential for the understanding of the embodiments of the invention are illustrated in FIG. 1. In other embodiments of the invention other components may be included.

The controller 7 is configured to control the apparatus 1. In the embodiment illustrated in FIG. 1 the controller 7 comprises a processor 3 and a memory 5. It is to be appreciated that in other embodiments of the invention one or more processors 3 and one or more memories 5 may be provided.

The processor 3 may be configured to read from and write to the memory 5. The processor 3 may also be configured to read from and write to the user interface 11 and the network interface 9 to enable the controller 7 to control the user interface 11 and the network interface 9.

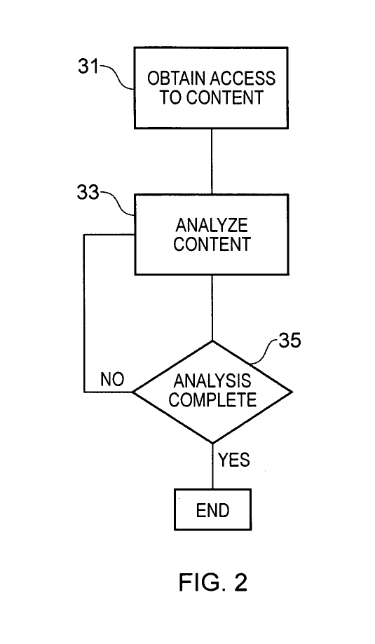

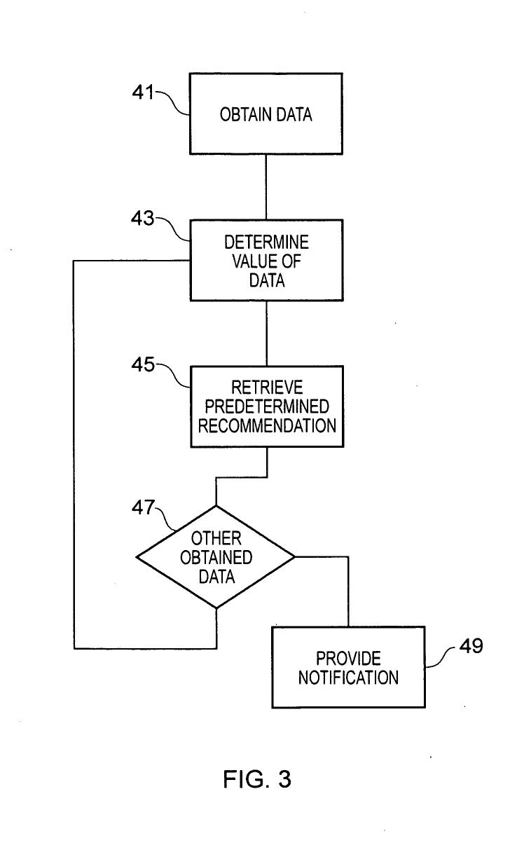

The memory 5 may be configured to store computer program instructions 13 which, when loaded into the processor 3 enable the apparatus 1 to perform the methods illustrated in FIGS. 2 and 3. The memory 5 may also be configured to store one or more predetermined recommendations 15. The predetermined recommendations 15 may provide instructions for modifying the content of a website or data associated with a website. For example, the predetermined recommendations 15 may provide instructions for amending the content which is provided to a user or changing other attributes of the website such as where the website is hosted or other factors which affect the search rating of the website.

The network interface 9 may comprise any means which enables the apparatus 1 to communicate with a network 17. The network 17 could be any network which enables remote apparatus to communicate with each other. For example, the network may comprise a wide area network such as the internet or a cellular communications network or a local area network such as a wireless local area network. The network interface 9 may communicate with the network via a communications link. The communications link may comprise a wireless communication channel or a wired connection or any other suitable link which enables data to be transferred between the apparatus 1 and the network 17.

The network 17 may comprise means for storing content such as websites and data relating to websites. The content may be stored on a server or any other suitable means. In some embodiments of the invention the content may be distributed at different locations within the network 17.

The user interface 13 may comprise any means which enables a user to interact with the apparatus 1. In the particular embodiment of the invention illustrated in FIG. 1 the user interface 13 comprises a user input device 19 and a user output device 21. The user input device 19 may comprise any means which enables a user to input data or information into the apparatus 1. For example, the user input device 19 may comprise a user actuable portion such as a keyboard or a touch screen or any other suitable means. Information which is input via the user input device 19 may be stored in the memory 5 and may be used to control the apparatus 1.

The user output device 21 may comprise any means which enables information to be provided to a user. For example it may comprise any audio or visual output means such as a display and a loudspeaker. The information which is provided via the user output device 21 may comprise information which is stored in the memory 5, information which has been input via the user input device 19 and information which has been obtained from the network 17 or any other information.

FIG. 2 illustrates a method according to embodiments of the invention. FIG. 2 illustrates a method of analyzing content according to embodiments of the invention.

At block 31 the controller 7 obtains access to content relating to a website. As mentioned above the content may comprise the text and or images which are provided to a user when they access a website and the content may also comprise data associated with the website such as the number of times the website has been accessed within a given time period or the number of times the website is linked by other websites or any other suitable information. Some of the content which is analyzed may be external to the website itself.

The content may be stored in the network 17 and may be obtained via the network interface 9.

The controller 7 may obtain access to the websites in response to a user inputting a unique identifier, such as a website address, via the user input device 19. In other embodiments of the invention the apparatus 1 may be configured to automatically scan the network 17 to find and access suitable websites without requiring any input from the user.

At block 33 the content is analyzed to provide data relating to the website.

The content may be analyzed using any suitable method. For example, in some embodiments of the invention the content may be analyzed by downloading a copy of the web page or pages that are present on the website. The content of the web page or web pages may then be analyzed.

In some embodiments of the invention the apparatus 1 may be configured to interrogate an external data source to obtain data associated with the website. For example, the apparatus 1 may communicate with a search engine provider to obtain data indicative of the number of pages from the website which are listed in the index of the search engine. This may be used to compare the number of pages that could appear in such indexes with the number of pages that actually appear in the indexes.

The apparatus 1 may also be configured to communicate with external computer systems, for example, in some embodiments of the invention the apparatus may communicate with computer systems which monitor and store data indicative of the number of websites hosted on a server. The data provided by this analysis could be indicative of whether or not the website is hosted on an optimal server.

In some embodiments of the invention the analysis comprises simulating the download of the website to determine the time it would take a typical user to download the website.

At block 35 the controller 7 determines whether or not the analysis of the website is complete. If the controller 7 determined that the analysis is not complete, for example, if there are other analysis that may be carried out the method returns to block 33 and a further analysis is carried out.

If the controller 7 determines that the analysis is complete then the analysis section of the method is completed and the controller may enable the method illustrated in FIG. 3 to be carried out.

FIG. 3 illustrates a further method according to embodiments of the invention. FIG. 3 illustrates a method which may be carried out once the analysis of the website has been completed.

At block 41 the controller obtains data relating to a website. The data may be obtained using the method described above in relation to FIG. 2.

At block 43 the controller 7 determines a value of the obtained data. For example the controller 7 may determine the number of times of the website is visited in a given time period or the number of other websites which link to the analyzed website.

At block 45 the controller 7 retrieves a predetermined recommendation 15 corresponding to the determined data value. The predetermined recommendation 15 may be stored in the memory 5. The predetermined recommendation 15 may be automatically retrieved from the memory 5 in response to the determination of the data value at block 43.

As mentioned above, the predetermined recommendation 15 may comprise instructions or information which may be used to improve the website. For example, it may comprise an indication of ways in which the content of the website or data associated with the website or any suitable attribute of the website may be amended to increase the search rating of the website.

The predetermined recommendation 15 may be one of a plurality of recommendations which may be stored in the memory 5. The predetermined recommendations may be created by a user of the apparatus 1. For example, the user of the apparatus may be able to input information using the user input device 19 which may be used to create the predetermined recommendations 15. The apparatus 1 may also be configured to enable the user to modify the predetermined recommendations. For example the user may be able to change the instructions or information contained within the recommendations or change the data value to which each recommendation corresponds. The user may also be able to delete the recommendations and add new recommendations.

The predetermined recommendation 15 may each be associated with one or more values of data relating to a website so that if the controller determines that the website has a particular value then the predetermined recommendation 15 may be retrieved in response to that determination. The predetermined recommendation 15 may be retrieved automatically without any input from the user of the apparatus 1.

At block 47 the controller 7 determines whether or not there are any other obtained data for which a data value is yet to be determined. If there are other obtained data then the method returns to block 43 and blocks 43 and 45 are repeated for the next piece of obtained data.

If the controller 7 determines that there are no other obtained data then the method moves to block 49 and the controller 7 controls the apparatus 1 to provide a notification of the retrieved predetermined recommendations 15. The notification may be provided on the user output device 21. For example a notification may be displayed on the display providing an indication of the retrieved predetermined recommendations. In other embodiments of the invention the notification may be provided by communicating the notification to a remote apparatus 1. For example the apparatus 1 may be configured to transmit the notification over the network 17 to a remote apparatus 1. The remote apparatus could be, for example, the mobile telephone of a user and the notification could be sent via a messaging service such as short messaging service (SMS) or an instant messaging or electronic mail service.

In some embodiments of the invention the apparatus 1 may be configured to enable the recommendations to be implemented. For example the apparatus may be configured to enable the content of the websites or the content associated with the websites to be changed. In some embodiments of the invention the recommendations may only be implemented in response to a user input. For example, before any of the recommendations are implemented it may be necessary for the user of the apparatus to select a user selectable option. In other embodiments of the invention it may be necessary for the user of the apparatus 1 to register with a service or pay a fee before the recommendations are implemented.

Embodiments of the invention provide the advantage that they enable the content of websites to be analyzed and provide a user with the option of modifying the content of the websites or content associated with the websites.

In embodiments of the invention a plurality of predetermined recommendations are associated with particular data values and stored in the memory 5 of the apparatus 1. These predetermined recommendations can then be quickly and easily retrieved once the analysis of the content has been carried out. This means that the recommendations can be generated quickly and efficiently so that the process may be carried out for a large number of websites or may be carried out more frequently.

The blocks illustrated in the FIGS. 2 and 3 may represent steps in a method and/or sections of code in the computer program 13. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed. For example in the above described embodiments the invention comprises a first method in which the websites are analyzed and a second method in which the recommendations relating to the websites are provided. These methods may be carried out by different modules and different computer programs may relate to each method. It is to be appreciated that in other embodiments of the invention the two method may be combined into a single process.

In some embodiments of the invention the methods may be carried out automatically without any input from a user. For example, the apparatus 1 may be configured to scan the network to find websites and associated content to analyze. In such embodiments of the invention the notifications may be configured to be sent to an appropriate owner of the website. In other embodiments of the invention the method may only be carried in response to a user input, for example it may be necessary for a user to input a web address or to authorize the analysis of the website.

In some embodiments of the invention the apparatus 1 may be configured to enable both automatic analysis of the websites and manual analysis of the websites. The manual analysis could comprise data which cannot be collected automatically, for example, an indication of the user friendliness or aesthetic quality of the website.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
at least one processor; and
at least one memory including computer program code;
wherein the at least one memory and the computer program code are configured to, with the at least one processor, enable the apparatus to:
obtain data relating to a website;
determine a value of the data; and
retrieve a stored recommendation corresponding to the determined value.

2. An apparatus as claimed in claim 1 further configured to analyze the website to obtain data from the website.

3. An apparatus as claimed in claim 1 further configured to analyze data associated with a website where the data is stored remotely from the website.

4. An apparatus as claimed in claim 1 wherein the data obtained relates to the search engine rating of the website.

5. An apparatus as claimed in claim 1 further configured to enable a user to modify the stored recommendations.

6. An apparatus as claimed in claim 5 wherein modifying the stored recommendations comprises the addition, deletion or editing of a stored recommendation.

7. An apparatus as claimed in claim 1 configured to provide a notification to a user where the user provides an indication of the stored recommendation.

8. An apparatus as claimed in claim 1 wherein the apparatus is configured to automatically obtain the data, determine the data value and retrieve a stored recommendation.

9. An apparatus as claimed in claim 1 configured to implement the retrieved recommendation.

10. A method comprising:
obtaining data relating to a website;
determining a value of the data; and
retrieving a stored recommendation corresponding to the determined value.

11. A method as claimed in claim 10 further comprising analyzing the website to obtain data from the website.

12. An apparatus as claimed in claim 10 further comprising analyzing data associated with a website where the data is stored remotely from the website.

13. A method as claimed in claim 10 wherein the data obtained relates to the search engine rating of the website.

14. A method as claimed in claim 10 further comprising enabling a user to modify the stored recommendations.

15. A method as claimed in claim 14 wherein modifying the stored recommendations comprises the addition, deletion or editing of a stored recommendation.

16. A method as claimed in claim 10 comprising providing a notification to a user where the user provides an indication of the stored recommendation.

17. A method as claimed in claim 10 comprising automatically obtaining the data, determining the data value and retrieving a stored recommendation.

18. A method as claimed in claim 10 comprising implementing the retrieved recommendation.

19. (canceled)

20. (canceled)

21. (canceled)

22. An apparatus comprising:
means for obtaining data relating to a website;
means for determining a value of the data; and
means for retrieving a stored recommendation corresponding to the determined value.
